(19) United States
(12) Patent Application Publication
(10) Pub. No.: US 2007/0244272 A1
(43) Pub. Date: Oct. 18, 2007

(54) Method for Separating Ammonia and Water From Mixtures, Arising During The Production of Polyamides

(75) Inventors: Jens Assmann, Mannheim (DE); Jurgen Demeter, Ludwigshafen (DE); Jurgen Deininger, Oftersheim (DE); Oliver Sotje, Mannheim (DE); Gad Kory, Gaiberg (DE); Jan-Martin Loning, Freinsheim (DE)

Correspondence Address: CONNOLLY BOVE LODGE & HUTZ LLP, 1875 EYE STREET, N.W., SUITE 1100, WASHINGTON, DC, 20036, US

(73) Assignee: BASF AKTIENGESELLSCHAFT, Ludwigshafen (DE)

(21) Appl. No.: 11/628,220

(22) PCT Filed: May 31, 2005
(86) PCT No.: PCT/EP05/05833

§ 371 Date: Dec. 1, 2006

(30) Foreign Application Priority Data
Jun. 2, 2004 (DE) 10 2004 027 022.8

(51) Int. Cl. C08J 11/06; C01C 1/02; C02F 1/04; C08G 69/16; C08G 69/28; C08J 11/02

(52) U.S. Cl. 526/64; 203/81; 203/82

(57) ABSTRACT

In a process for distillatively removing ammonia and water from mixtures obtained in the preparation of polyamides which comprise a lactam and/or diamines, and, if appropriate, an aminonitrile and/or dinitrile, and also a cyclopentanone impurity in two stages: 1) the mixture is distilled at from 11 to 35 bar to give, as the top product T1, water, ammonia and cyclopentanone, and, as the bottoms B1, water, the lactam and/or diamines, and, if appropriate, the aminonitrile and/or dinitrile, and 2) T1 is distilled at from 11 to 35 bar to give, as the top product T2, ammonia and cyclopentanone, and, as the bottoms B2, water.

The invention relates to a process for distillatively removing ammonia and water from the mixtures obtained in the preparation of polyamides, said mixtures comprising not only ammonia and water but also a lactam and/or diamine, and if appropriate an aminonitrile and/or dinitrile, and a cyclopentanone impurity, which comprises effecting the removal in at least two stages 1 and 2 by,

in stage 1, subjecting the mixture to a distillation at an absolute pressure of from 11 to 35 bar and a bottom temperature of from 180 to 260° C., in which the top product T1 obtained is an at least partly gaseous mixture comprising water and ammonia and the bottoms B1 obtained are a mixture comprising water, the lactam and/or diamine, and, if appropriate, the aminonitrile and/or dinitrile, and the cyclopentanone is fully removed as the top product, and,

in stage 2, subjecting the resulting top product T1 to a further distillation at an absolute pressure of from 11 to 35 bar and a bottom temperature of from 180 to 260° C. to obtain a mixture comprising ammonia and cyclopentanone as the top product T2 and water as the bottoms B2.

The invention further relates to the use of this process in a process for preparing polyamides, and to a process for preparing polyamides, which comprises removing ammonia and water from the mixtures obtained therein by the process specified at the outset.

Aqueous solutions which comprise a lactam or other polyamide starting materials, ammonia and small amounts of cyclopentanone are obtained, for example, in the course of the preparation of polyamides. For example, 6-aminocapronitrile (ACN) can be reacted with water, under catalysis or else uncatalyzed, to give 6-aminohexanolactam (caprolactam) and ammonia, the resulting reaction mixture comprising undesired by-products including cyclopentanone and typically also unconverted nitrile, e.g. ACN, and this reaction mixture can be further converted to nylon-6 (PA 6). Lactams in the context of this application are both monomeric and oligomeric lactams.

For nylon-6,6, it is possible, for example, to react adiponitrile (ADN) and hexamethylenediamine (HMD) with water, under catalysis or else uncatalyzed, to give oligomers or prepolymers of PA66 and ammonia, the resulting reaction mixture comprising undesired by-products including cyclopentanone and typically also unconverted nitrile, e.g. ADN, or unconverted diamine, e.g. HMD, and to convert this reaction mixture further to nylon-6,6 (PA 66).

The workup of the aqueous, ammoniacal reaction mixture mentioned is costly and inconvenient. Processes for polyamide preparation can be operated in an economically advantageous manner especially when substantially all constituents of the reaction mixture can be recycled. However, the constituents to be recycled have to be of particularly high purity, since the concentration of the impurities would otherwise be increased locally at the destination of the recycling, in the sense of undesired “enrichment” of the impurities.

In addition, the end group concentrations in the polymer or else the polymer color number have to satisfy high demands and remain very constant over time. This means that impurities in the feedstocks or streams to be recycled have to be minimized to a very substantial extent.

WO 95/14665 and WO 95/14664 describe the reaction of ACN in the liquid phase with water in the presence of heterogeneous catalysts and a solvent to give a solution comprising caprolactam and ammonia. No workup of this solution is described.

WO 00/20488 and WO 99/38908 teach the reaction of ACN in the liquid phase with water in the presence of heterogeneous catalysts to give a liquid phase comprising nylon-6 and prepolymers thereof and water, and to give a gas phase comprising caprolactam and unconverted aminonitrile, water and ammonia. A workup of this gas phase is described such that the separation into the constituents is generally effected continuously with the aid of a distillation apparatus such as a distillation column. The thus removed organic constituents such as caprolactam or aminonitrile which is unconverted to a predominant extent may be recycled fully or partly into the polymerization or hydrolysis process. There is no mention of the handling of by-products or impurities.

WO 01/94308 describes the separation of a solution comprising a lactam and ammonia such that ammonia is distilled out of the solution at a pressure of less than 10 bar absolute. The aim is to obtain ammonia in very pure form, if appropriate by using a second distillation column for the abovementioned distillate. A bottom product consisting substantially of lactam is available for further use, for example for polymerization to PA 6. Here too, there is no mention of by-products or impurities.

A fundamental disadvantage of the processes mentioned is that by-products formed in the hydrolysis or cyclization of ACN, especially the aforementioned cyclopentanone, but also hexamethylenediamine and N-methylcaprolactam are not removed from the mixture obtained as the bottoms in the distillation. The bottoms are a product of value, since they comprise substantially unconverted aminonitrile or lactam. It would be economically very advantageous to recycle this product of value for the purpose of materials integration back into the upstream hydrolysis process or to the polymerization in the downstream polymerization process. As mentioned, the purity of the substances is of particular significance for the recycling of the streams removed and their material reintegration.

The by-products have an adverse effect on the polymer properties; see, for example, DE-A 24 10 863. In particular, they bring about a deterioration in the color number (APHA or Hazen number, or yellow number). The moldings or fibers obtained from such polyamides have a troublesome intrinsic color which is undesired in many applications. In addition, the intrinsic color complicates the coloring of polyamides to give a precise hue.

In the hydrolysis process of ACN, the recycling of the by-product-containing bottoms additionally harbors the disadvantage that a later removal of the troublesome by-products such as cyclopentanone is no longer possible. In the cyclization processes of ACN, the bottoms have to be purified in complicated additional steps in order to avoid the abovementioned disadvantages. In addition, undesired locally elevated impurity concentrations occur.

It is an object of the present invention to remedy the disadvantages outlined. In particular, a process should be provided which enables the removal of ammonia and water from mixtures which comprise ammonia, water, a lactam and/or diamine, and if appropriate aminonitrile and/or dinitrile, in a technically simple and economically viable manner. In addition, the process should remove cyclopentanone and other by-products which are either not removed at all or are only removed by additional purification steps from the bottoms (product of value) of the separation stages.

Accordingly found have been the process defined at the outset, its use in a process for preparing polyamides, and a process for preparing polyamides, which comprises removing ammonia and water from the mixtures obtained therein by the process specified at the outset. Preferred embodiments of the invention can be taken from the subclaims.

All pressure data are absolute pressures. The units ppm and ppb relate to the mass, i.e. are parts per million by weight and parts per billion by weight respectively.

The invention starts from a mixture as is formed, for example, in the reaction of ACN or other nitrites with water to give lactams or in the reaction of dinitrile and diamine. Such a mixture comprises, for example, the lactam, and also water as excess water, or, in the case of a reaction in the gas phase, as water used to quench the reaction effluent, and also ammonia (in an amount of 1 mol per mole of lactam) and typically also unconverted aminonitrile. An impurity which is also present is cyclopentanone. Further impurities as can be formed as by-products in the reaction mentioned may likewise be present in the mixture, just like organic solvent.

A further such mixture comprises, for example, adiponitrile and/or hexamethylenediamine, and also water as excess water. Cyclopentanone is also present as an impurity. Further impurities, as can occur as by-products in the reaction mentioned, may likewise be present in the mixture, just like organic solvents.

Lactam may be any customary lactam, especially those which can be converted to polyamides. Preference is given to lactams of C₄-C₂₀-omega-carboxylic acids, e.g. 4-aminobutanolactam, 5-aminopentanolactam, 6-aminohexanolactam (“caprolactam”), 7-aminoheptanolactam or 8-aminooctanolactam, more preferably caprolactam. These lactams may be substituted, for example by C₁₋₄-alkyl groups, halogens such as fluorine, chlorine or bromine, C₁₋₄-alkoxy groups or C₁₋₄-carboxyl groups. However, the lactams are preferably unsubstituted. It is also possible to use mixtures of such lactams. Such lactams are known to those skilled in the art.

Such lactams can be prepared by reacting the corresponding aminonitriles with water, for example, in the case of caprolactam, by reacting 6-aminocapronitrile, as described, for example, in EP-A-0 659 741, WO 95/14664, WO 95/14665, WO 96/22874, WO 96/22974, WO 97/23454, WO 99/28296 or WO 99/47500. Suitable starting materials for polyamide preparation are described hereinbelow.

The aminonitrile used may in principle be any aminonitrile, i.e. compounds which have both at least one amino and at least one nitrile group. Among these, preference is given to ω-aminonitriles, and those used among the latter are in particular ω-aminoalkylnitriles having from 4 to 12 carbon atoms, more preferably from 4 to 9 carbon atoms, in the alkylene radical, or an aminoalkylarylnitrile having from 8 to 13 carbon atoms, and preference is given there to those which have an alkyl spacer having at least one carbon atom between the aromatic unit and the amino and nitrile group. Among the aminoalkylarylnitriles, preference is given in particular to those which have the amino and nitrile group in the 1,4-arrangement relative to one another.

The ω-aminoalkylnitrile used is more preferably a linear ω-aminoalkylnitrile, and the alkylene radical (—CH₂—) comprises preferably from 4 to 12 carbon atoms, more preferably from 4 to 9 carbon atoms, such as 6-amino-1-cyanopentane (6-aminocapronitrile), 7-amino-1-cyanohexane, 8-amino-1-cyanoheptane, 9-amino-1-cyanooctane, 10-amino-1-cyanononane, more preferably 6-aminocapronitrile.

6-Aminocapronitrile is obtained typically by hydrogenating adiponitrile by known processes, described, for example, in DE-A 836 938, DE-A 848 654 or U.S. Pat. No. 5,151,543.

It will be appreciated that it is also possible to use mixtures of a plurality of aminonitriles or mixtures of one aminonitrile with further comonomers, for example caprolactam or the mixture defined in detail below.

The dinitrile used may in principle be any dinitrile, i.e. compounds which have at least two nitrile groups. Among these, preference is given to α,ω-dinitriles, and those used among the latter are in particular α,ω-dinitriles having from 4 to 12 carbon atoms, more preferably from 4 to 9 carbon atoms, in the alkylene radical, or an cyanoalkylarylnitrile having from 7 to 12 carbon atoms, and preference is given there to those which have an alkyl spacer having at least one carbon atom between the aromatic unit and the two nitrile groups. Among the cyanoalkylarylnitriles, preference is given in particular to those which have the two nitrile groups in the 1,4-arrangement relative to one another.

The α,ω-alkylenedinitrile used is preferably a linear α,ω-alkylenedinitrile, and the alkylene radical (—CH₂—) comprises preferably from 3 to 11 carbon atoms, more preferably from 3 to 8 carbon atoms, such as 1,4-dicyanobutane (adiponitrile), 1,5-dicyanopentane, 1,6-dicyanohexane, 1,7-dicyanoheptane, 1,8-dicyanooctane, 1,9-dicyanononane, 1,10-dicyanodecane, more preferably adiponitrile.

The diamine used may in principle be any diamine, i.e. compounds which have at least two amino groups. Among these, preference is given to α,ω-diamines, and those used among the latter are in particular α,ω-diamines having from 4 to 14 carbon atoms, more preferably from 4 to 10 carbon atoms, in the alkylene radical, or an aminoalkylarylamine having from 7 to 12 carbon atoms, and preference is given there to those which have an alkyl spacer having at least one carbon atom between the aromatic unit and the two nitrile groups. Among the aminoalkylarylamines, preference is given in particular to those which have the two amino groups in 1,4-arrangement relative to one another.

The α,ω-alkylenediamine used is more preferably a linear α,ω-alkylenediamine, and the alkylene radical (—CH₂—) comprises preferably from 3 to 12 carbon atoms, more preferably from 3 to 8 carbon atoms, such as 1,4-diaminobutane, 1,5-diaminopentane, 1,6-diaminohexane (hexamethylenediamine), 1,7-diaminoheptane, 1,8-diaminooctane, 1,9-diaminononane, 1,10-diaminodecane, more preferably hexamethylenediamine.

If desired, it is also possible to use diamines, dinitriles and aminonitriles which derive from branched alkylene- or arylene- or alkylarylenes, such as 2-methylglutaronitrile or 2-methyl-1,5-diaminopentane.

When dinitriles and diamines or a mixture comprising dinitrile, diamine and aminonitrile are used in the preparation of polyamides, an advantageous molar ratio of the nitrile groups which are capable of polyamide formation and are present in the feedstocks to amino groups which are capable of polyamide formation and are present in the feedstocks has been found to be in the range from 0.9 to 1.1, preferably from 0.95 to 1.05, in particular from 0.99 to 1.01, more preferably of 1.

Further polyamide-forming monomers which may be used are, for example, dicarboxylic acids such as alkanedicarboxylic acids having from 6 to 12 carbon atoms, in particular from 6 to 10 carbon atoms, such as adipic acid, pimelic acid, suberic acid, azeleic acid or sebacic acid, and also terephthalic acid, isophthalic acid and cyclohexanedicarboxylic acid, or amino acids such as aminoalkanoic acids having from 5 to 12 carbon atoms, especially α,ω-C₅-C₁₂-amino acids.

The α,ω-C₅-C₁₂-amino acid used may be 5-aminopentanoic acid, 6-aminohexanoic acid, 7-aminoheptanoic acid, 8-aminooctanoic acid, 9-aminononanoic acid, 10-aminodecanoic acid, 11-aminoundecanoic acid and 12-aminododecanoic acid, preferably 6-aminohexanoic acid, or their internal amides, known as lactams, especially caprolactam.

Suitable starting materials for polyamide preparation are also mixtures with aminocarboxylic acid compounds of the general formula I
R²R³N—(CH₂)ₘ—C(O)R¹ (I)
in which R¹ is —OH, —OC₁₋₁₂-alkyl or —NR²R³, and R² and R³ are each independently hydrogen, C₁₋₁₂-alkyl and C₅₋₈-cycloalkyl, and m is 3, 4, 5, 6, 7, 8, 9, 10, 11 or 12.

Particularly preferred aminocarboxylic acid compounds are those in which R¹ is OH, —O—C₁₋₄-alkyl such as —O-methyl, —O-ethyl, —O-n-propyl, —O-isopropyl, —O-n-butyl, —O-sec-butyl, —O-tert-butyl and —NR²R³ such as —NH₂, —NHMe, —NHEt, —NMe₂ and —NEt₂, and m is 5.

Very particular preference is given to 6-aminocaproic acid, methyl 6-aminocaproate, ethyl 6-aminocaproate, N-methyl-6-aminocaproamide, N,N-dimethyl-6-aminocaproamide, N-ethyl-6-aminocaproamide, N,N-diethyl-6-aminocaproamide and 6-aminocaproamide.

Suitable starting materials for polyamide preparation are also mixtures with dicarboxylic acid compounds of the general formula II
X²C—(CH₂)ₘ—CX¹ (II)
in which X¹ and X² are each —N, —OOH, —OOC₁₋₁₂-alkyl or —ONR²R³, and R² and R³ are each independently hydrogen, C₁₋₁₂-alkyl and C₅₋₈-cycloalkyl, and m is 3, 4, 5, 6, 7, 8, 9, 10, 11 or 12.

Particularly preferred dicarboxylic acid compounds are those in which X¹ and X² are each N, OOH, —OO—C₁₋₄-alkyl such as —OO-methyl, —OO-ethyl, —OO-n-propyl, —OO-n-butyl, —OO-sec-butyl, —OO-tert-butyl and —ONR²R³ such as —ONH₂, —ONHMe, —ONHEt, —ONMe₂ and —ONEt₂, and m is 5.

Very particular preference is given to adipic dinitrile (adiponitrile), adipic mononitrile monoamide, adipic diamide (adipamide), adipic monoamide, adipic acid, adipic mononitrile.

The starting compounds are commercially available or can be prepared, for example, according to EP-A 234 295 and Ind. Eng. Chem. Process Des. Dev. 17 (1978) 9-16.

It is also possible to use any mixtures of the compounds, aminocarboxylic acid compounds, lactams, diamines and diacids mentioned or salts thereof.

The polyamide-forming monomers used are preferably aminonitriles or dinitriles and diamines or mixtures comprising aminonitrile, dinitrile and diamine, together with water, more preferably in a molar ratio in the range from 1:1 to 1:20 based on the overall process. Particular preference is given to aminocapronitrile at a molar ACN:water ratio in the overall process of from 1:1 to 1:10. Particular preference is further given to a mixture of adiponitrile and hexamethylenediamine at a molar ratio of the sum of adiponitrile and hexamethylenediamine:water in the overall process of from 1:1 to 1:10. Particular preference is further given to a mixture of adiponitrile, hexamethylenediamine and aminocapronitrile at a molar ratio of the sum of adiponitrile, hexamethylenediamine and aminocapronitrile:water in the overall process of from 1:1 to 1:10.

It is also possible to use mixtures of polyamide-forming monomers and oligomers.

The polyamide-forming monomers used in addition to aminocapronitrile are, if desired, preferably caprolactam and/or hexamethylenediammonium adipate (“AH salt”).

The polyamide-forming monomers used in addition to adiponitrile and hexamethylenediamine are, if desired, preferably caprolactam and/or hexamethylenediammonium adipate (“AH salt”).

In the mixture to be separated in accordance with the invention, it is also possible for oligomeric, such as dimeric, trimeric, tetrameric, pentameric, hexameric, amides or polymeric amides to be present. Oligomeric amides refer to compounds or mixtures thereof which are obtainable by joining a small number, for example from 2 to 6, of monomers such as aminonitriles, preferably 6-aminocapronitrile, or dinitriles, preferably adiponitrile, with diamines, preferably hexamethylenediamine, or mixtures of such monomers.

Polymeric amides refer to homopolymers or copolymers, such as random or block copolymers, or mixtures thereof which have repeating amide groups (—CONH—) in the polymer main chain. Such amides are obtainable in a manner known per se from the above-described monomers, for example aminonitriles, preferably 6-aminocapronitrile, or dinitriles, preferably adiponitrile, with diamines, preferably hexamethylenediamine.

The process according to the invention for removing ammonia and water from the mixture mentioned will be described in detail hereinbelow.

The mixture used in accordance with the invention may be monophasic (for example gaseous or liquid), biphasic (for instance gaseous/liquid or liquid/solid) or triphasic (gaseous/liquid/solid). Useful solids are in particular prepolymers of the lactam, for example PA6 prepolymers. Also useful are prepolymers of dinitrile and diamine, for example PA66 prepolymers. Preference is given to feeding the mixture to the distillation apparatus (see below) as a gaseous feed.

According to the invention, the distillative removal is undertaken in at least two stages 1 and 2 (in contrast to the one-stage distillation described in WO 01/94308). Preference is given to working continuously, i.e. the mixture to be separated is fed continuously to the distillation apparatus from which a top product and bottoms are drawn off continuously.

In stage 1, the mixture is subjected to a distillation at an absolute pressure of from 11 to 35 bar and a bottom temperature of 180 to 260° C. The pressure is preferably from 13 to 32 bar, more preferably from 15 to 30 bar. The bottom temperature is preferably from 190 to 245° C. and more preferably from 195 to 230° C.

The higher pressure of from 11 to 35 bar distinguishes the present invention from the process claimed in WO 01/94308, according to which the pressure is less than 10 bar, preferably less than 8 bar.

The distillation separates the mixture into a top product T1 and bottoms B1. The top product T1 comprises a mixture comprising water and ammonia. In addition, it may comprise small amounts of the lactam and/or diamine and/or dinitrile, typically a maximum of 1000 ppm, preferably a maximum of 500 ppm, in particular a maximum of 100 ppm.

In addition, the top product T1 comprises the cyclopentanone: according to the invention, the cyclopentanone is removed fully as the top product. This is not intended to rule out the possibility of small amounts of cyclopentanone remaining in the bottoms B1.

According to the invention, the top product T1 is drawn off at least partly in gaseous form, gaseous including vapor. In particular, the ammonia which has been drawn off is at least partly in gaseous form. Preferably from 60 to 100% by weight of the ammonia present in the top product T1 which has been drawn off is present as a gas. This distinguishes the process according to the invention from the comparative example of the aforementioned WO 01/94308, according to which the ammonia is condensed fully at the top of the column.

The bottoms B1 comprise a mixture comprising water, the lactam and/or diamine and, if appropriate, unconverted aminonitrile and/or dinitrile. It preferably comprises no more than 500 ppm, in particular not more than 200 ppm, of ammonia. The bottoms B1 preferably comprise a maximum of 100 ppm, in particular not more than 10 ppm and most preferably not more than 1 ppm, of cyclopentanone.

Owing to this high purity, the bottoms B1 may be used as feedstock, for example in the preparation of polyamides or prepolymers thereof (in this case, for example, the lactam is converted to PA 6).

Consequently, in a preferred embodiment, the bottoms B1 are transferred as a feedstock into a process for preparing polyamides. Particular preference is given to transferring the bottoms B1, owing to their high purity, directly and without further purification into this process for polyamide preparation. This is economically very advantageous, since costly and inconvenient purification steps are dispensed with.

A suitable reactor for preparing PA 6 or PA 66 or copolyamides, for example, a biphasic reactor having a plurality of chambers, arranged one on top of the other, which are connected to one another by liquid overflows and by gas distributors equipped with guide plates, and the PA 6 or PA 66 product is drawn off from the bottom of this reactor. Such a reactor is described, for example, in the application DE reference number 10313681.9 of Mar. 26, 2003 and the subsequent PCT application reference number PCT/EP/04/002875 of Mar. 19, 2004.

Distillation pressure and distillation temperature in stage 1 of the removal process according to the invention should preferably be selected such that a stream comprising substantially ammonia, water and cyclopentanone can be drawn off overhead in gaseous form or at least partly in gaseous form, and the mixture comprising water, lactam and/or diamine and, if appropriate, aminonitrile and/or dinitrile remains in the bottom.

Useful distillation apparatus is customary single-stage or multistage apparatus, as described, for example, in Kirk-Othmer, Encyclopedia of Chemical Technology, 3rd Ed., Vol. 7, John Wiley & Sons, New York, 1979, page 870-881, such as evaporation stills or rectification columns, for example sieve tray columns, bubble-cap tray columns, or columns having structured or random packing. It is possible to use, for example, single-stage distillation stills, pure stripping columns or rectification columns having stripping and rectifying section.

Particular preference is given to recycling at least part of the bottoms B2 as reflux to stage 1; see below.

In stage 2, the top product T1 obtained in the first distillation is subjected to a further distillation at an absolute pressure of from 11 to 35 bar and a bottom temperature of from 180 to 260° C. The pressure is preferably from 13 to 19 bar, more preferably from 15 to 18 bar. The bottom temperature is preferably from 190 to 211° C. and more preferably from 195 to 207° C.

The further distillation separates the top product T1 into a top product T2 and bottoms B2. The top product T2 comprises a mixture comprising ammonia and cyclopentanone, i.e. the impurities are drawn off overhead. A portion of the top product T2 may be condensed and recycled as reflux into the second distillation apparatus.

It is possible to remove ammonia in a customary manner from the top product T2, for example by distillation, and use it further as a product of value.

The bottoms B2 comprise substantially water. The bottoms B2 are preferably water of high purity. It can be used directly and without further purifying operations, for example as hydrolysis water in the hydrolysis of the aminonitrile or dinitrile or mixture thereof, or as extraction water in the extraction of nylon-6 which typically follows the preparation of PA6.

In a particularly preferred embodiment, the bottoms B2 (water) are recycled fully or partly as reflux into stage 1, i.e. the bottoms B2 of the second distillation column are introduced fully or partly as reflux to the first column. This embodiment enables a particularly substantial removal of cyclopentanone with the top product T1.

Distillation pressure and distillation temperature in stage 2 of the process should preferably be selected such that a stream comprising substantially ammonia and cyclopentanone is drawn off overhead, and water remains in the bottom. The top product may be drawn off in gaseous form, at least partly in gaseous form or, if appropriate after condensation, also in liquid form.

Useful distillation apparatus for stage 2 is the apparatus already mentioned for the first distillation (stage 1).

In general, the feed of the second distillation, i.e. the at least partly gaseous top product T1 of the first distillation, is condensed before it is fed to the second distillation apparatus. This may be effected, for example, by means of customary condensers. There is typically no recycling of this condensed top product T1 into the first distillation stage in order to successfully remove the cyclopentanone via the top product T1.

It is possible and preferred to combine the apparatus of stages 1 and 2, for example in thermally coupled distillation columns or in dividing wall columns. This apparatus is described by Kaibel et al., Chemie Ingenieur Technik 2004, 76, No. 3, page 258-263. This allows the inventive distillative removal to be implemented at a low level of apparatus complexity and energy intensity.

It has been found that the inventive removal can again be distinctly improved when a dividing wall column having an internal intermediate condensation stage above the dividing wall and a customary top condenser is used, compared with a customary dividing wall column without intermediate condenser. Particular preference is given to a process in which the removal is undertaken in a dividing wall column having internal intermediate condenser.

The additional intermediate condensation conducts an additional liquid serving to achieve the separating task between low and medium boilers in countercurrent to the vapor streams rising in the column without the reflux which is generated via the top condenser and is crucial for the separation of low and medium boilers in the upper section of the distillation column being affected. This preferred embodiment reduces the operating and capital costs distinctly compared to the conventional operation of a dividing wall column without intermediate condenser.

When stages 1 and 2 are carried out as described in a dividing wall column with an additional intermediate condenser and the aqueous solution which is to be separated and comprises lactam or diamine and/or dinitrile, ammonia and small amounts of cylopentanone is condensed and fed partly in gaseous form to the dividing wall column, the bottom product of the dividing wall column which is typically obtained is a mixture of the composition of the bottom product B1 of stage 1, the side withdrawal stream is a mixture of the composition of the bottom product B2 of stage 2, and the top product is a mixture of the composition of the top product T2 of stage 2.

The bottom, side withdrawal and top product streams of the dividing wall column which have been mentioned have the same advantages with regard to their purity as are obtained in the embodiment, described above, of the invention with two stages in separate apparatus.

Over and above stages 1 and 2, the process according to the invention may have further stages which are configured as described below. For example, the top product T2 may be subjected to a further distillation in order to separate ammonia, cyclopentanone and other by-products.

The process according to the invention enables the removal of ammonia and water from mixtures which comprise ammonia, water, a lactam and/or diamine and, if appropriate, aminonitrile and/or dinitrile in a technically simple and economically viable manner. In particular, the process provides bottoms B1 which do not comprise any cyclopentanone as a troublesome by-product and can thus be used without further purification in the polyamide preparation.

The invention therefore also provides the use of the removal process described in a process for preparing polyamides, and also a process for preparing polyamides, which comprises removing ammonia and water from the mixtures obtained therein by the removal process described.

Polyamides which are prepared using the cyclopentanone-free bottoms B1 obtained by the process according to the invention feature better properties, especially a distinctly lower color number and a lower intrinsic color. Such polyamides can be colored to a precise hue and are especially also suitable as uncolored material for visually demanding moldings.

### EXAMPLES

### Example 1

A mixture A composed of 77.0% by weight of water, 13.9% by weight of ammonia, 9.1% by weight of caprolactam, 0.004% by weight of cyclopentanone and 0.045% by weight of CO₂ was fed continuously in an amount of 12.2 kg/h as a gaseous feed at a pressure of 21 bar absolute and a temperature of 235° C. to a first distillation column. The diameter of the column was 50 mm; the total height of the separating section of the column was 6000 mm. The rectifying section of the column was charged with structured packings. The stripping section was charged with bubble-cap trays. The bottom temperature was 220° C.

The top product T1 of the first column was drawn off fully in gaseous form at 210° C. and 21 bar of pressure in an amount of 18.3 kg/h and had the following composition: 90.7% by weight of water, 9.2% by weight of ammonia, 6 ppm of caprolactam, 275 ppm of CO₂ and 33 ppm of cyclopentanone.

The top product T1 was condensed fully and fed continuously at an absolute pressure of 17 bar and a temperature of 170° C. to a second distillation column. The diameter of the column was 80 mm; the total height of the separating section of the column was 7000 mm. Rectifying section the stripping section of the column were charged with bubble-cap trays. The bottom temperature was 205° C.

The top product T2 of the second column was condensed fully at 44° C. and 17 bar of pressure. A portion of this condensate in an amount of 1.7 kg/h was drawn off and had the following composition: 2.5% by weight of water, 97.2% by weight of ammonia, 0.3% by weight of CO₂ and 230 ppm of cyclopentanone. The remaining condensate stream was introduced as reflux to stage 2.

The bottoms B2 of the second column were drawn off at 205° C. and 17 bar in an amount of 16.5 kg/h and had the following composition: 99.9% by weight of water, 6 ppm of caprolactam, 50 ppm of ammonia, 10 ppm of cyclopentanone and <1 ppm of CO₂. Accordingly, the water obtained was of high purity.

A portion of these bottoms B2 (8.5 kg/h) was recycled as reflux to the first distillation column.

The bottoms B1 of the first column were drawn off at 220° C. in an amount of 2.443 kg/h and had the following composition: 54.9% by weight of water, 45.1% by weight of caprolactam, <20 ppm of ammonia, <1 ppb of CO₂ and <35 ppb of cyclopentanone.

The bottoms B1 were conducted into a reactor R and polymerized there to give PA 6. The longitudinal axis of the reactor R was vertical and its reaction product was discharged from the reactor bottom. Ammonia which had formed and any further low molecular weight compounds and water which had formed were drawn off from the reactor R overhead. The reactor R had five chambers arranged one on top of the other in longitudinal direction which were separated from one another by liquid-tight trays. Each chamber was connected to the chamber lying directly below by a liquid overflow. From the liquid overflow of the lowermost chamber, a liquid product stream was drawn off. The gas space above the liquid level in each chamber was joined to the chamber directly above in each case by a guide tube which opened in each case into a gas distributor having orifices for gas discharge below the liquid level. Around each gas distributor was disposed vertically a guide plate whose upper end ended below the liquid level and whose lower end ended above the liquid-tight tray of the chamber and which separated each chamber into a sparged and into an unsparged space.

In the upper section of the reactor R, a prepolymer was metered in which had been obtained from the hydrolysis of 30 kg of ACN with 30 kg of water in a pressure reactor at an average residence time of 1.5 h at 80 bar after subsequent decompression to 230° C. and 25 bar and separation of a gas phase G.

The gas phase drawn via the top of the reactor R was combined with the gas phase G so as to give a total gas phase of 12.2 kg/h comprising 77.0% by weight of water, 13.9% by weight of ammonia, 9.1% by weight of caprolactam, 0.004% by weight of cyclopentanone and 0.045% by weight of CO₂. (This overall gas phase is the mixture A.)

The reactor R was operated at 28 bar of elevated pressure and a controlled bottom temperature of 275° C. The temperature profile in the reactor developed adiabatically. The total residence time in the reactor R was 1.65 hours including a residence time in the bottom region of less than 10 minutes.

From the bottom region of the reactor R, 31.4 kg/h of a product stream composed of PA 6 with 8.9% by weight of water were drawn off. The product stream was subsequently postcondensed in a customary manner in a fully continuous flow tube (“VK tube”). To remove the oligomers, the thus obtained nylon-6 was extracted with water in a manner known per se and subsequently dried.

### Example 2 (For Comparison)

The procedure of example 1 was repeated, but the mixture, according to the prior art WO 01/94308, was separated at a pressure of 5 bar. The top product was drawn off in gaseous form in an amount of 1.79 kg/h and was composed of 5.5% by weight of water, 94.2% by weight of ammonia, <1 ppm of caprolactam, 0.02% by weight of cyclopentanone and 0.3% by weight of CO₂. A portion of the top product was condensed and introduced back to the column at a temperature of 71° C. From the bottom, 10.4 kg/h of a mixture of 89.3% by weight of water, <1000 ppm of ammonia, 10.6% by weight of caprolactam; 10 ppm of cyclopentanone and 1 ppm of CO₂ were drawn off at 152° C.

Some of the streams mentioned were determined with the aid of mathematical models.

The examples show that the process according to the invention was able to remove troublesome impurities fully from the bottoms B1. In particular, the bottoms B1 of the inventive example comprised only 35 ppb of cyclopentanone, the bottoms of the comparative example in contrast 10 ppm, i.e. about 300 times the amount of cyclopentanone. The bottoms B1 could be used without further purification directly in the PA6 preparation.

1. A process for distillatively removing ammonia and water from mixtures obtained in the preparation of polyamides, said mixtures comprising not only ammonia and water but also a lactam and/or a diamine, and optionally, an aminonitrile and/or dinitrile, and a cyclopentanone impurity, which comprises effecting the removal in at least two stages 1 and 2 by,
in stage 1, subjecting the mixture to a distillation at an absolute pressure of from 11 to 35 bar and a bottom temperature of from 180 to 260° C., in which the top product T1 obtained is an at least partly gaseous mixture comprising water and ammonia and the bottoms B1 obtained are a mixture comprising water, the lactam and/or the diamine and optionally, the aminonitrile and/or dinitrile, and the cyclopentanone is fully removed as the top product, and,
in stage 2, subjecting the resulting top product T1 to a further distillation at an absolute pressure of from 11 to 35 bar and a bottom temperature of from 180 to 260° C. to obtain a mixture comprising ammonia and cyclopentanone as the top product T2 and water as the bottoms B2.

2. The process according to claim 1, wherein the bottoms B2 are recycled partly or fully into stage 1 as reflux.

3. The process according to claim 1, wherein the lactam is present and the lactam is caprolactam.

4. The process according to claim 1, wherein the diamine is present and the diamine is hexamethylenediamine.

5. The process according to claim 1, wherein the dinitrile is present and the dinitrile is adiponitrile.

6. The process according to claim 1, wherein the aminonitrile is present and the aminonitrile is aminocapronitrile.

7. The process according to claim 1, wherein the bottoms B1 are transferred as a feedstock into a process for preparing polyamides.

8. The process according to claim 1, wherein the bottoms B1 are transferred directly and without further purification into the process for preparing polyamides.

9. The process according to claim 1, wherein the bottoms B1 comprise not more than 1 ppm of cyclopentanone.

10. The process according to claim 1, wherein the water obtained as the bottoms B2 is transferred into the process for preparing polyamides.

11. The process according to claim 1, wherein the water obtained as the bottoms B2 is transferred directly and without further purification into the process for preparing polyamides.

12. The process according to claim 1, wherein the removal is undertaken in a dividing wall column having internal intermediate condenser.

13. A method for preparing a polyamide comprising isolating a polyamide from the process as claimed in claim 1.

14. A process for preparing a polyamide comprising removing ammonia and water from the mixtures obtained therein by the process according to claim 1.

15. The process according to claim 2, wherein the lactam is present and the lactam is caprolactam.

16. The process according to claim 2, wherein the diamine is present and the diamine is hexamethylenediamine.

17. The process according to claim 2, wherein the dinitrile is present and the dinitrile is adiponitrile.

18. The process according to claim 2, wherein the aminonitrile is present and the aminonitrile is aminocapronitrile.

19. The process according to claim 2, wherein the bottoms B1 are transferred as a feedstock into a process for preparing polyamides.

20. The process according to claim 3, wherein the bottoms B1 are transferred as a feedstock into a process for preparing polyamides.
